(19) United States
(12) Patent Application Publication
(10) Pub. No.: US 2002/0049735 A1
(43) Pub. Date: Apr. 25, 2002

(54) Sound retrieval apparatus, and sound data recording apparatus

(76) Inventors: Izumi Matsumoto, Yokohama-shi (JP); Kazuhiro Onizuka, Yokohama (JP)

Correspondence Address: PEARNE & GORDON LLP, 526 SUPERIOR AVENUE EAST, SUITE 1200, CLEVELAND, OH, 44114-1484, US

(21) Appl. No.: 09/920,542

(22) Filed: Aug. 1, 2001

(30) Foreign Application Priority Data
Aug. 2, 2000 (JP) 2000-234857
Jul. 31, 2001 (JP) 2001-232672

(51) Int. Cl. G06F 7/00

(52) U.S. Cl. 707/1

(57) ABSTRACT

A sound retrieval apparatus (10) comprises decoding means (12) for decoding sound data into sound signals respectively on channels, assigning means (13) for assigning the channels to the speakers (101, 102, 103, 104, 105a, and 105b) based on the channel assignment information about a specific association between the channels and the speakers, information storing means (16) for storing the channel assignment information, and control means (17) for controlling the assigning means (13) based on the channel assignment information. The sound retrieval apparatus (10) thus constructed can retrieve the sound without any laborious task such as the manual operation with the output patch board whenever any channel is reassigned.

### BACKGROUND OF THE INVENTION

1. Field of the Invention

The present invention relates to a sound retrieval apparatus for retrieving sound in three-dimensional sound field by way of a plurality of speakers, and more particularly to a sound retrieval apparatus which can switch assignment of a plurality of channels for transmitting sound signals thereon to a plurality of speakers.

2. Description of the Related Art

One typical example of the conventional sound retrieval apparatus is shown in FIG. 11. In FIG. 11, the conventional sound retrieval apparatus 1 constitutes a multi-channel surround system accompanied by a surround speaker system 2. The surround speaker system 2 comprises a left speaker 2a, a right speaker 2b, a center speaker 2c, a sub woofer 2d, and a plurality of surround speakers 2e and 2f. The surround speaker system 2 is adapted to receive a plurality of sound signals different from one another for having sound in three-dimensional sound field outputted, thereby providing an audience with the presence in a stereo hall.

The respective speakers is operative to output the sound in accordance with the respective sound signals decoded from sound data. The sound data is encoded in advance in accordance with a format pattern defining the association between the sound data and the speakers.

The format pattern is generally selected based on the replaying in a three-dimensional sound field planned by a producer from among various format patterns. There are a wide variety of format patterns in view of the three-dimensional sound field, viz., there are a wide variety of combinations of channels and speakers, such as a format pattern for outputting sound from the LRC (left, right, and center) speakers 2a, 2b and 2c emphasized thereon, and a format pattern for outputting sound from the surround speakers 2e and 2f emphasized thereon.

In order to monitor various sound data encoded with a wide variety of format patterns one after another, the conventional sound retrieval apparatus 1 was employed by the producer.

The conventional sound retrieval apparatus 1 is shown in FIG. 11 as comprising a decoding unit 3 for decoding the sound data into the sound signals on the different six channels maximum, a plurality of amplifiers 4 for amplifying the sound signals on every channel, and an output patch board 5 for completing the connection between the decoding unit 3 and the speakers 2a, 2b, 2c, 2d, 2e and 2f.

The output patch board 5 forming part of the sound retrieval apparatus 1 is designed to have the combination of the channels and the speakers changed by the manual operation. The combination of the channels and the speakers is changed one after another with the manual operation at the output patch board 5, so that the various sound data encoded in the various format patterns is monitored one after another.

The conventional sound retrieval apparatus encounters such a problem that the format pattern changed is inevitable to entail the changing operation of the combination of the channels and the speakers, thereby resulting in the fact that the output patch board is operated to change the combination of the channels and the speakers. This means that laborious tasks are needed for completion of the changing operation stated in the above.

### SUMMARY OF THE INVENTION

It is therefore an object of the present invention to provide a sound retrieval apparatus which can overcome the foregoing drawbacks inherent in the conventional sound retrieval apparatus and which does not require any device such as the output patch board incorporated in the conventional sound retrieval apparatus, viz., being dispensed with the operation at the output patch board for changing the combination of the channels having the sound signals transmitted thereon and the speakers provided the sound signal thereto.

It is another object of the present invention to provide a sound retrieval apparatus which is excellent in operation without any laborious task.

A first aspect of the sound retrieval apparatus according to the present invention is provided that to decode sound data encoded in advance into a plurality of sound signals to be provided to a plurality of speakers for outputting sound in a three-dimensional sound field, the sound signals being respectively related to a plurality of channels, comprising; decoding means for decoding the sound data into the sound signals respectively on the channels, assigning means for assigning the channels to the speakers respectively based on the channel assignment information about a specific association between the channels and the speakers, information storing means for storing the channel assignment information, and control means for controlling the assigning means based on the channel assignment information to ensure that the sound signals on the channels are provided to the respective speakers in association with the channels.

The sound retrieval apparatus according to the present invention thus constructed as previously mentioned can assign the channels for transmitting the sound signals thereon to the speakers provided the sound signals thereto based on the channel assignment information stored in the information storing means without any laborious task at the output patch board.

A second aspect of the sound retrieval apparatus according to the present invention is that the control means is operative to judge whether there is sound data on the respective channels or not to cause the speakers in association with the channels having no sound data thereon to be inoperative.

The sound retrieval apparatus according to the present invention thus constructed as previously mentioned can substantially cut off the channels having no sound data.

A third aspect of the sound retrieval apparatus according to the present invention further comprises output level adjusting means for adjusting the output levels of the sound signals respectively on the channels.

The sound retrieval apparatus according to present invention thus constructed as previously mentioned can provide the speakers with the sound signals adjusted in the output levels on the respective channels.

A fourth aspect of the sound retrieval apparatus according to the present invention is that the output level adjusting means is operative to adjust the output levels of the sound signals based on the output level information about a specific association between the channels and the output levels of the sound signals respectively on the channels, and the information storing means is operative to store the output level information.

The sound retrieval apparatus according to the present invention thus constructed as previously mentioned can adjust the output levels of the sound signals without manual operation whenever the assignment between the channels and the speakers is switched.

A fifth aspect of the sound retrieval apparatus according to the present invention is that the output level adjusting means is operative to adjust respective the sound signals in equivalent ratio having the sound signals on the channels maintained in balance with one another.

The sound retrieval apparatus according to present invention thus constructed as previously mentioned can collectively adjust the output levels of all of the sound signals and can maintain the balance of the output levels.

A sixth aspect of the sound retrieval apparatus according to the present invention further comprises selecting means for selecting the sound signals decoded by the decoding means, and summing means for summing the sound signals selected by the selecting means to output summed sound signals to respective the speakers.

The sound retrieval apparatus according to the present invention thus constructed as previously mentioned can provide to any speaker with the sound signals flexibly selected and summed in case of necessity. Further, the speakers for monitoring may be cut downed.

A seventh aspect of the sound retrieval apparatus according to the present invention further comprises display means for displaying the output levels of the sound signals respectively on the channels.

The sound retrieval apparatus according to present invention thus constructed as previously mentioned can visually confirm the output levels of the sound signals on the respective channels.

A eighth aspect of the sound retrieval apparatus according to the present invention for decoding sound data encoded in advance into a plurality of sound signals to be provided to a plurality of speakers for outputting sound in a three-dimensional sound field, the sound signals being respectively related to a plurality of channels, comprising; decoding means for decoding the sound data into the sound signals respectively on the channels, assigning means for assigning the channels to the speakers respectively in accordance with the identification data identifying a specific association between the channels the speakers, detecting means for detecting the identification data attached to the sound data; control means for controlling the assigning means in accordance with the identification data to ensure that the sound signals on the channels are provided to the respective speakers in association with the channels.

The sound retrieval apparatus according to the present invention thus constructed as previously mentioned can assign the channels for transmitting the sound signals thereon to the speakers inputted the sound signals thereto in accordance with the identification data detected by the detecting means without any laborious task with the manual operation at the output patch board.

A ninth aspect of the sound retrieval apparatus according to the present invention is that the control means is operative to judge whether there is sound data on the respective channels or not to cause the speakers in association with the channels having no sound data thereon to be inoperative.

The sound retrieval apparatus according to the present invention thus constructed as previously mentioned can substantially cut off the channels having no sound data.

A tenth aspect of the sound retrieval apparatus according to the present invention further comprises output level adjusting means for adjusting the output levels of the sound signals respectively on the channels.

The sound retrieval apparatus according to present invention thus constructed as previously mentioned can provide to the speakers with the sound signals adjusted in the output levels on the respective channels.

A eleventh aspect of the sound retrieval apparatus according to the present invention is that the output level adjusting means is operative to adjust the output levels of the sound signals based on the output level information about a specific association between the channels and the output levels of the sound signals respectively on the channels, and the information storing means is operative to store the output level information.

The sound retrieval apparatus according to the present invention thus constructed as previously mentioned can adjust the output levels of the sound signals without manual operation whenever the assignment between the channels and the speakers is switched.

A twelfth aspect of the sound retrieval apparatus according to the present invention is that the output level adjusting means is operative to adjust respective the sound signals in equivalent ratio having the sound signals on the channels maintained in balance with one another.

The sound retrieval apparatus according to present invention thus constructed as previously mentioned can collectively adjust the output levels of all of the sound signals and can maintain the balance of the output levels.

A thirteenth aspect of the sound retrieval apparatus according to the present invention further comprises selecting means for selecting the sound signals decoded by the decoding means, and summing means for summing the sound signals selected by the selecting means to output summed sound signals to respective the speakers.

The sound retrieval apparatus according to the present invention thus constructed as previously mentioned can provide any speaker with the sound signals flexibly selected and summed in case of necessity. Further, the speakers for monitoring may be cut downed.

A fourteenth aspect of the sound retrieval apparatus according to the present invention further comprises display means for displaying the output levels of the sound signals respectively on the channels.

The sound retrieval apparatus according to present invention thus constructed as previously mentioned can visually confirm the output levels of the sound signals on the respective channels.

The sound data recording apparatus according to the present invention is provided to record sound data encoded in advance from a plurality of sound signals to be provided to a plurality of speakers replaying sound in a three-dimensional sound field, the sound signals being respectively related to a plurality of channels, comprising; input means for having the identification data identifying a specific association between the channels the speakers inputted thereto; and recording means for recording the identification data attached to the sound data.

The sound data recording apparatus according to the present invention thus constructed as previously mentioned can record the identification data identifying a specific association between channels and the speakers with the sound data.

### BRIEF DESCRIPTION OF THE DRAWINGS

The features and advantages of the present invention will more clearly be understood from the following description taken in conjunction with the accompanying drawing in which:

FIG. 1 is a block diagram of the first embodiment of the sound retrieval apparatus according to the present invention;

FIG. 2 is an example of the output level information;

FIG. 3 is an example of the sound data with a format number as identification data;

FIG. 4 is a flowchart of the process in the case that the format number is obtained from a recording medium according to the first embodiment of the sound retrieval apparatus of the present invention;

FIG. 5 is a flowchart of the process in the case that the format number is obtained with the operation unit according to the first embodiment of the sound retrieval apparatus of the present invention;

FIG. 6 is a block diagram of the second embodiment of the sound retrieval apparatus according to the present invention;

FIG. 7 is a block diagram of the main part of the second embodiment of the sound retrieval apparatus;

FIG. 8 is a block diagram of the embodiment of the sound data recording apparatus according to the present invention;

FIG. 9 is an example of the attribute information in the case of the DVD specification standardized by the DVD forum;

FIG. 10 is an example of the channel assignment information in the case of the DVD specification standardized by the DVD forum; and

FIG. 11 is a block diagram of a conventional sound retrieval apparatus.

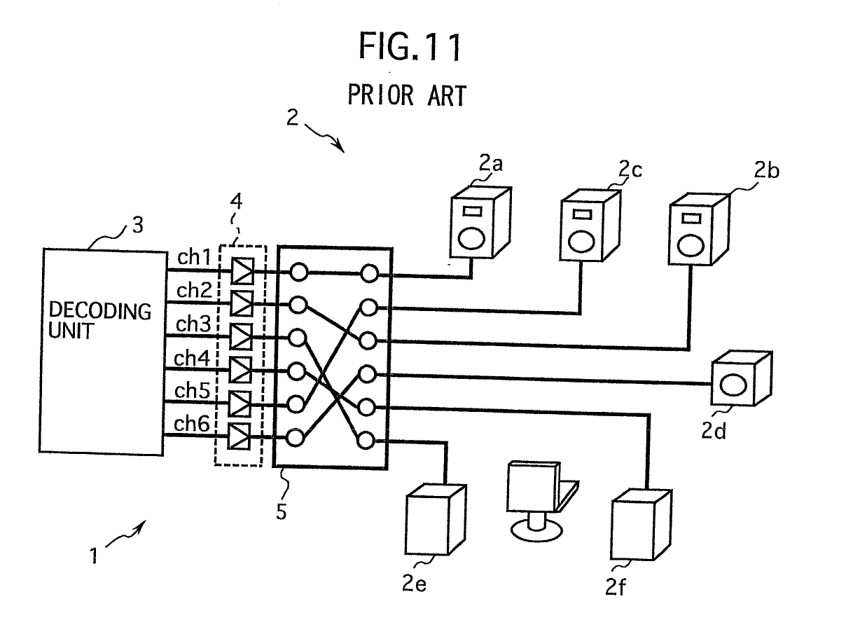

### DESCRIPTION OF THE PREFERRED EMBODIMENTS

The embodiments of the sound retrieval apparatus and the sound data recording apparatus according to the present invention will be described hereinafter with reference to the accompanying drawings.

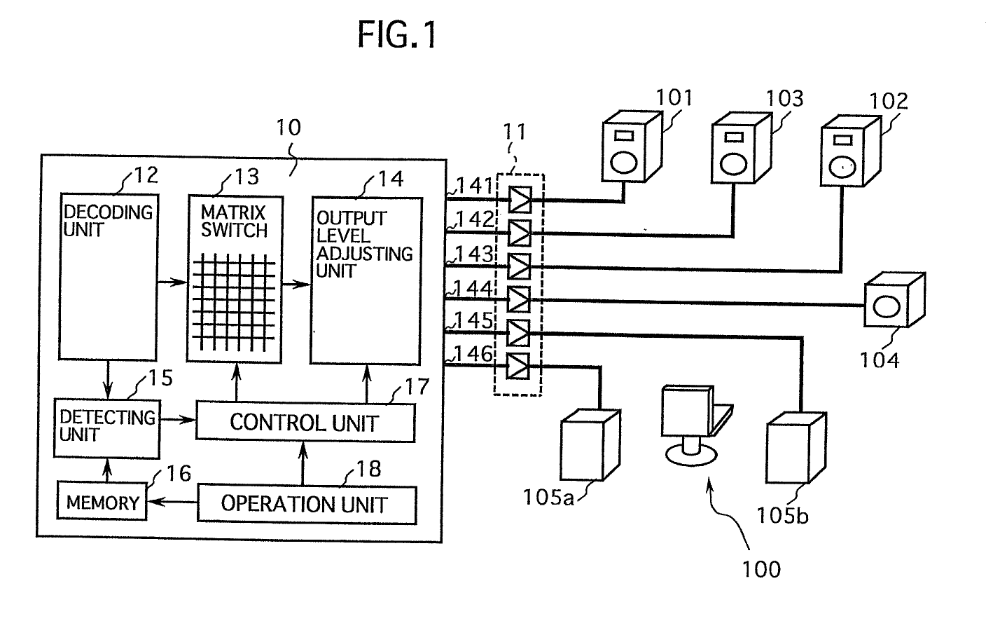

Referring now to the drawings in particular to FIGS. 1 to 5, there is shown a first embodiment of the sound retrieval apparatus according to the present invention.

The sound retrieval apparatus is shown in FIG. 1 as being indicated by the reference numeral 10 is electrically connected with a surround speaker system 100 having a plurality of speakers. The surround speaker system 100 is adapted to receive a plurality of sound signals different from one another for having sound in three-dimensional sound field outputted, thereby providing an audience with the presence in a stereo hall. The sound retrieval apparatus 10 raised as the first embodiment is operative to decode the sound data encoded in advance into the sound signals on the different six channels maximum.

The surround speaker system 100 is constituted by different kinds of speakers consisting of a left speaker 101, a right speaker 102, a center speaker 103, a sub woofer 104, and a plurality of surround speakers 105a and 105b. The speakers 101, 102, 103, 104, 105a and 105b are connected with a plurality of amplifiers 11 respectively. The amplifiers 11 are electrically connected with the sound retrieval apparatus 10 at a plurality of output terminals 141, 142, 143, 144, 145 and 146, respectively. The amplifiers 11 are operative to amplify the respective sound signals outputted from the respective output terminals 141, 142, 143, 144, 145 and 146.

The sound retrieval apparatus 10 is designed to decode the sound data encoded in advance into the sound signals on the respective channels and output the sound signals to the respective speakers from the respective output terminals 141, 142, 143, 144, 145 and 146.

The channels having the sound signals transmitted thereon are assigned to the speakers based on the channel assignment information about the specific association between the channels and the speakers.

The sound retrieval apparatus 10, as shown in FIG. 1, comprises a decoding unit 12, a matrix switch 13, an output level adjusting unit 14, a detection unit 15, a memory 16, a control unit 17, and an operation unit 18.

The decoding unit 12 constitutes decoding means for decoding the sound data into the sound signals respectively on the channels. The switch matrix 13 constitutes assigning means for assigning the channels having the sound signals transmitted thereon to the speakers based on the channel assignment information about a specific association between the channels and the speakers. The output level adjusting unit 14 constitutes output level adjusting means for adjusting the output levels of the sound signals respectively on the channels based on the output level information about a specific association between the channels and the output levels of the sound signals. The detection unit 15 constitutes detection means for detecting a format number as identification data attached to the sound data. The memory 16 constitutes information storing means for storing the channel assignment information and the output level information. The control unit 17 constitutes control means for controlling the switch matrix 13 based on the channel assignment information to ensure that the sound signals respectively on the channels are provided to the respective speakers in association with the channels.

The decoding unit 12 is operative to decode the sound data previously encoded and recorded, the sound data being related to the respective channels in a recording medium. The sound data is decoded into the sound signals on the respective channels and outputted to the switch matrix 13 by the decoding unit 12.

Further, the decoding unit 12 is operative to obtain the attribute information attached to the sound data in the recording medium. The attribute information includes the format number as identification data identifying the channel assignment information about the specific association between the channels and the speakers. The format number also identifies the output level information. The format number is outputted to the detection unit 15 by the decoding unit 12.

The matrix switch 13 is operative to have the sound signals on the respective channels inputted from the decoding unit 12. The channels are assigned to the respective speakers 101, 102, 103, 104, 105a and 105b by the matrix switch 13 based on the channel assignment information. The sound signals are provided to the respective speakers on the respective channels. More particularly, the matrix switch 13 has a plurality of internal output terminals respectively corresponding to the respective speakers to have the sound signals outputted to the output level adjustment unit 14. The internal output terminals are selected based on the channel assignment information by the switch matrix 13, so that the sound signals from the decoding unit 12 are outputted to the output level adjustment unit 14 through the internal output terminals.

The output level adjustment unit 14 is operative to adjust the output levels of the respective sound signals based on the output level information to output the respective sound signals through the respective output terminals 141, 142, 143, 144, 145 and 146. The respective output levels are adjusted in accordance with the operation at the operation unit 18. Further, the respective output levels may be adjusted in accordance with the identification data detected by the detection unit 15.

Further, the level adjustment unit 14 is operative to substantially cut off the channels having no sound data. More specifically, the control unit 17 is operative to judge whether there is sound data on the respective channels or not, and the level adjustment unit 14 is operative to forcibly adjust the output levels to zero in association with the channels having no sound data so that the speakers in association with the channels each having no sound data to be inoperative.

While this embodiment of the sound retrieval apparatus 10 comprises the output level adjustment unit 14 operative to cut off the channels having no sound data, the switch matrix 13 may cut off the channels having no sound data instead of the output level adjustment unit 14. More specifically, the control unit 17 is operative to judge whether there is sound data on the respective channels or not, and the switch matrix 13 is operative to cut off the channels having no sound data to the speakers.

The detection unit 15 is operative to detect the format number from the attribute information obtained by the decoding unit 12. The channel assignment information corresponding to the format number is obtained from the memory 16 by the detection unit 15 and the channel assignment information is outputted to the control unit 17 by the detection unit 15.

In addition, the detection unit 15 is operative to obtain output level information corresponding to the format number from the memory 16 and output the output level information to the control unit 17.

The memory 16 is operative to store the channel assignment information for every format number and the output level information for every format number. The channel assignment information is about a specific association between the channels and the speakers. Here, the output level information is intended to indicate a specific association between the channels and the output levels.

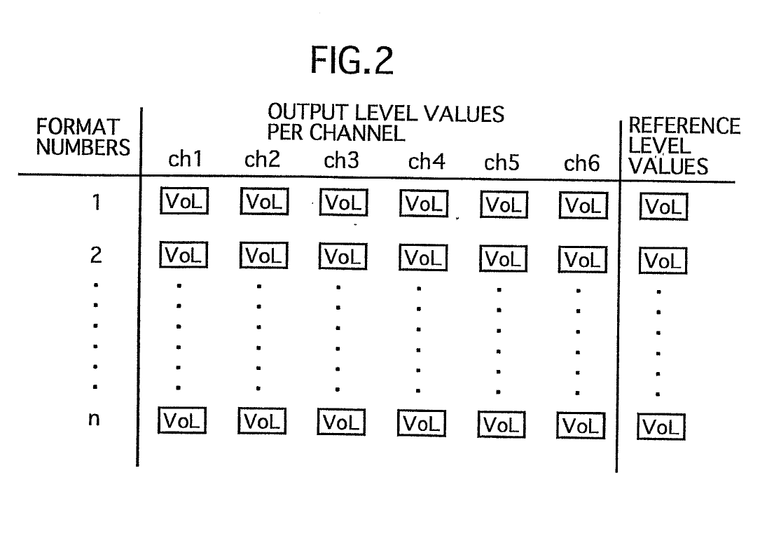

FIG. 2 shows an example of the output level information per format number. The output level information comprises output level values per channel and format number, and a reference level value per format number. The output level values per channels and the reference level value are outputted from the memory 16 to the detecting unit 15 in accordance with the format number detected by the detecting unit 15.

When any one of format numbers is inputted by the operation unit 18, the channel assignment information and the output level information are outputted from the memory 16 to the detecting unit 15 in accordance with the format number inputted by the operation unit 18. The channel assignment information and the output level information obtained by the detection unit 15 are outputted to the control unit 17.

The output level information stored in the memory 16 includes output level values per channel and format number, and a reference level value per format number. In this embodiment of the present invention, each of the output level values indicates a ratio of each sound output level to a whole sound output level, and the real output levels of the respective sound signals are adjusted based on the output level values and the reference level value by the output level adjusting unit 14.

Further, the output level values stored in the memory 16 will be renewed in accordance with the current sound level changed by the operation unit 18. In this embodiment of the present invention, when respective sound levels on the respective channels are changed by the operation unit 18, the output level values corresponding to the current format number are renewed in ratio according to the changed sound levels.

In addition, the output level value may be renewed while the reference level value in the memory 16 is by no means renewed. In the case that the output levels over the all channels are changed by the operation unit 18, the output levels of the sound signals on the respective channels are adjusted in equivalent ratio by the output level adjusting unit 14 without renewal of the reference level value stored in the memory 16. For example, in the case that the output levels at the channel 1 with 10dB, the channel 2 with 15dB, and channel 3 with 10dB each is adjusted based on the output level information, the output levels are changed in the same ratio+5dB, so that channels 1, 2 and 3 will be 15dB, 20dB, and 15dB, respectively, for maintaining the output levels in balance without the renewal of the reference level value.

The control unit 17 is operative to control the matrix switch 13 based on the channel assignment information stored in the memory 16. The control unit 17 is further operative to control the output level adjusting unit 14 based on the output level information stored in the memory 16. The control unit 17 is also operative to control the matrix switch 13, the output level adjusting unit 14, the memory 16, and the other parts of the sound retrieval apparatus 10 in accordance with the operation at the operation unit 18.

The operation unit 18 is operative to accept operations for controlling the matrix switch 13 and the output level adjusting unit 14. The operation unit 18 is further operative to accept operations for writing the information into the memory 16 and for reading the information from the memory 16.

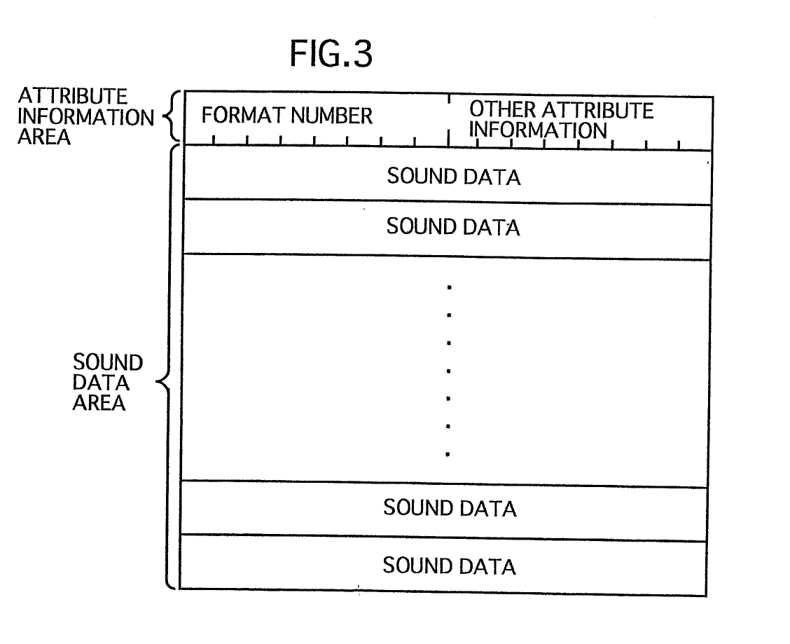

FIG. 3 shows an example of the sound data with the attribute information. The sound data attached the attribute information is recorded in the recording medium such as an DVD (Digital Video Disk) and a hard disk generally used in the personal computer.

The sound data is recorded as being related to a plurality of channels in the sound data area, while the format number and other attribute information are recorded in the attribute area.

The attribute information obtained by the decoding unit 12 is outputted to the detecting unit 15, and the format number and other attribute information are detected by the detecting unit 16. The sound data obtained by the decoding unit 12 is outputted to the matrix switch 13.

Further, the attribute information is obtained by the decoding unit 12 before the sound data is obtained.

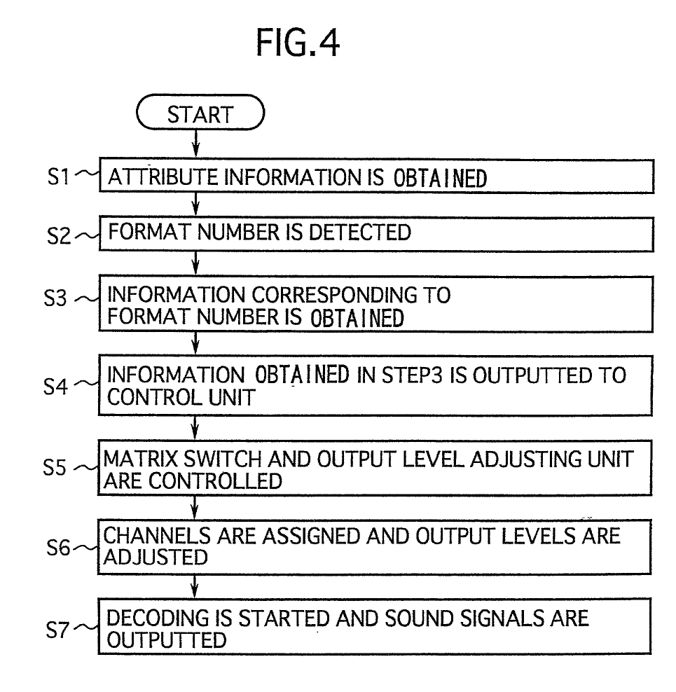

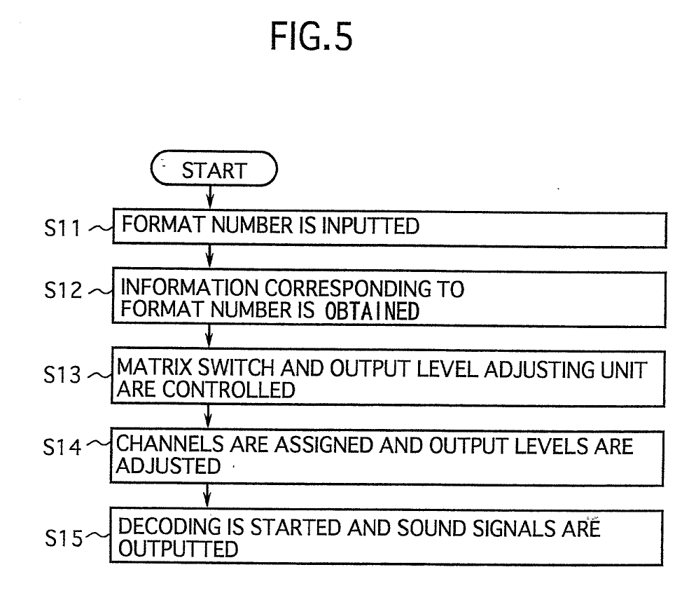

Referring to the drawings FIG. 4 and FIG. 5, there are shown the processes of the first preferred embodiment of the sound retrieval apparatus according to the present invention.

Now, the process in the case that the format number is obtained from the recording medium will then be described with reference to FIG. 4. The FIG. 4 is a flowchart indicating the process in each part of the sound retrieval apparatus 10 in the case that the format number is obtained from the recording medium.

It is assumed that the sound data is previously encoded and recorded in the recording medium, and that the format number is included in the attribute information attached to the sound data.

In step S1, the attribute information is obtained form the recording medium and outputted to detecting unit 15 by the decoding unit 12.

In step S2, a format number is detected among the attribute information by the detection unit 15.

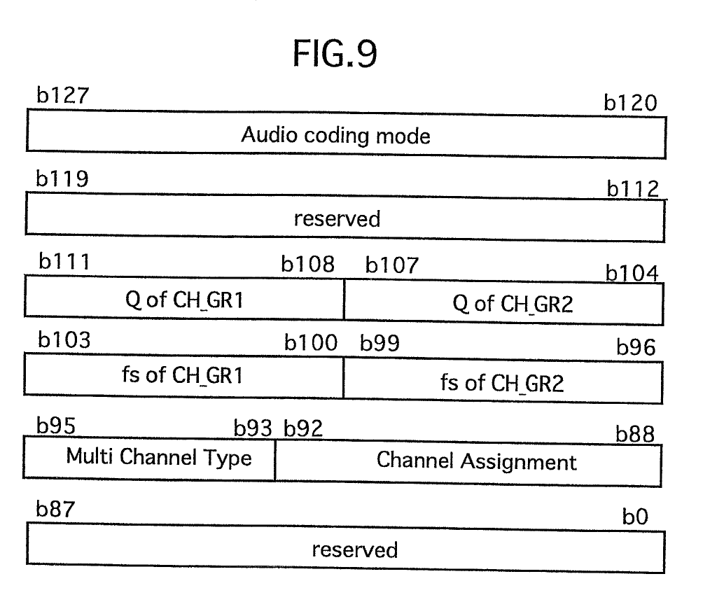

In the case of the sound data encoded in the DVD specification standardized by the DVD forum, the value of “Channel Assignment” is obtained as the format number form the ATS (Audio Title Set) information. The “Channel Assignment” is from bit 88 to bit 92 of the ATS information as shown in FIG. 9.

In step S3, the channel assignment information corresponding to the format number is obtained and the output level information corresponding to the format number is also obtained from the memory 16 by the detecting unit 15.

In step S4, the channel assignment information corresponding to the format number is outputted and the output level information corresponding to the format number is also outputted to the control unit 17 by the detecting unit 15.

In step S5, the state of the matrix switch 13 is set under the control of the control unit 17 based on the channel assignment information corresponding to the format number. In addition, the state of the level adjusting unit 14 is set under the control of the control unit 17 based on the output level information corresponding to the format number.

In step S6, the channels for transmitting the sound signals thereon are assigned to the speakers inputted the sound signals thereto by the matrix switch 13 based on the channel assignment information corresponding to the format number. In addition, the output levels of the respective sound signals are adjusted by the output level adjusting unit 14 based on the output level information corresponding to the format number.

In step S7, the decoding of the sound data into the respective sound signal is started in the decoding unit 12 under the control of the control unit 17. The sound signals on the respective channels are outputted from the sound retrieval apparatus 10 to the speakers of the surround speaker system 100.

As stated above, the format number is obtained from the recording medium so that the preparations for providing the sound signals are completed in accordance with the format number. The decoding of the sound data into the sound data and the outputting of the sound signals to the speakers are immediately started after the preparations.

Next, the process in the case that the format number is inputted with the operation unit 18 will then be described with reference to FIG. 5. FIG. 5 is a flowchart indicating the process in each part of the sound retrieval apparatus 10 in the case that the format number is inputted with the operation by the operation unit 18.

In step S11, any of the format numbers is inputted with the operation unit 18.

In step S12, the channel assignment information corresponding to the format number is obtained and the output level information corresponding to the format number is also obtained from the memory 16 by the detecting unit 15.

In step S13, the state of the matrix switch 13 is set under the control of the control unit 17 based on the channel assignment information corresponding to the format number. In addition, the state of the output level adjusting unit 14 is set under the control of the control unit 17 based on the output level information corresponding to the format number.

In step S14, the channels for transmitting the sound signals thereon are assigned to the speakers inputted the sound signals thereto by the matrix switch 13 based on the channel assignment information corresponding to the format number. In addition, the output levels of the respective sound signals are adjusted by the output level adjusting unit 14 based on the output level information corresponding to the format number.

In step S15, the decoding of the sound data into the respective sound signals is started in the decoding unit 12 under the control of the control unit 17. The sound signals on the respective channels are outputted from the sound retrieval apparatus 10 to the speakers of the surround speaker system 100.

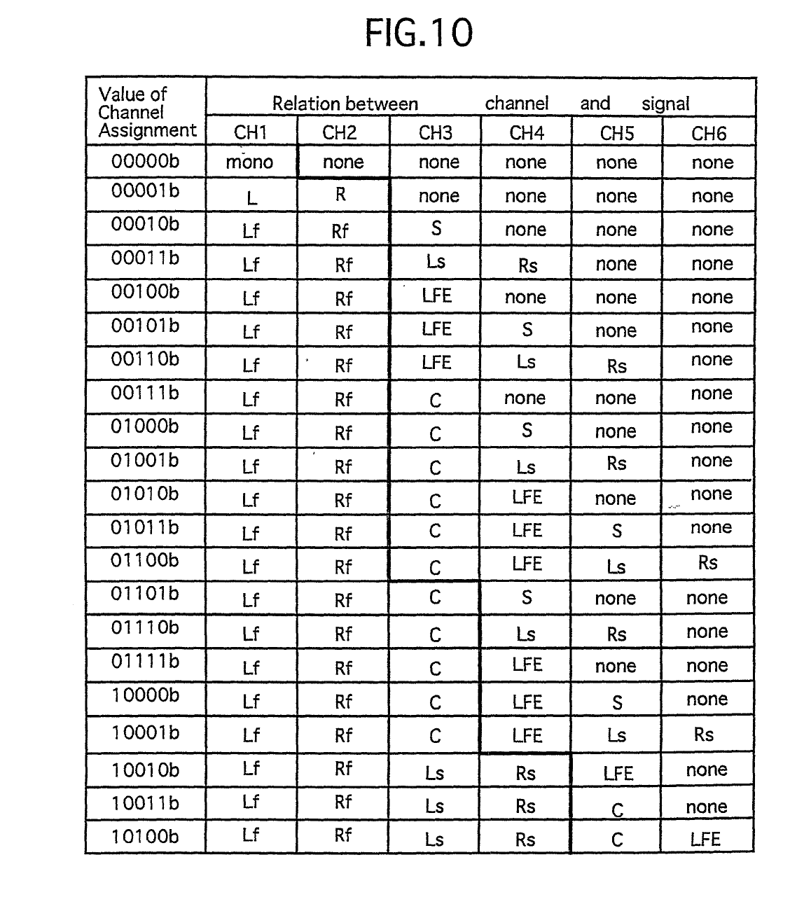

FIG. 10 is an example of the channel assignment information in the case that the sound data is encoded in the DVD specification standardized by the DVD forum. In the FIG. 10, symbol “L” indicates the left speaker, symbol “Lf” also indicates the left speaker as a left front speaker, symbol “R” indicates the right speaker, symbol “Rf” also indicates the right speaker as a right front speaker, symbol “C” indicates the center speaker, symbol “LFE” indicates the sub woofer as a low frequency effect speaker, symbol “Ls” indicates the left surround speaker, symbol “Rs” indicates the right surround speaker, and symbol “S” indicates the surround speakers. The value of “Channel Assignment” as the format number is obtained form the ATS (Audio Title Set) information as shown in FIG. 9.

As stated above, the format number is inputted with the operation unit 18 so that the preparations for providing the sound signals are completed in accordance with the format number. The decoding of the sound data into the sound data and the outputting of the sound signals to the speakers may be immediately started after the preparation.

From the foregoing description, it will be understood that the sound retrieval apparatus 10 according to the present invention thus constructed as previously mentioned can provide the speakers with the sound signals on the respective channels without any device for manual operation such as output patch board incorporated in the conventional sound retrieval apparatus and without any laborious operation.

Also, the sound retrieval apparatus 10 according to the present invention can provide the speakers with the sound signals on the respective channels only with the operation for inputting the format number.

While the number of the channels is six in the first embodiment of the sound retrieval apparatus 10, the number of the channel is not limited to six in the present invention. The number of the channel may be less than six or larger than six.

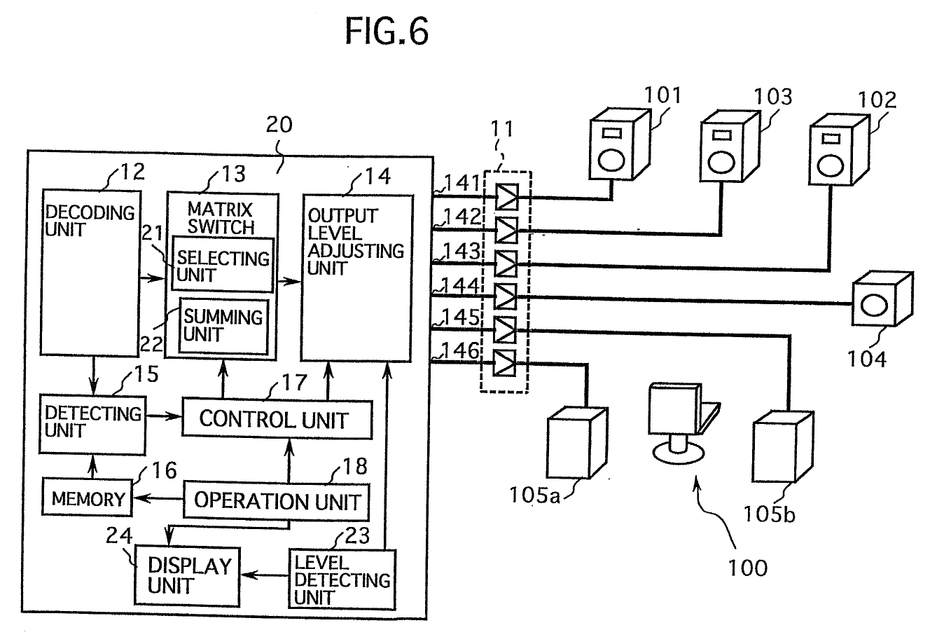

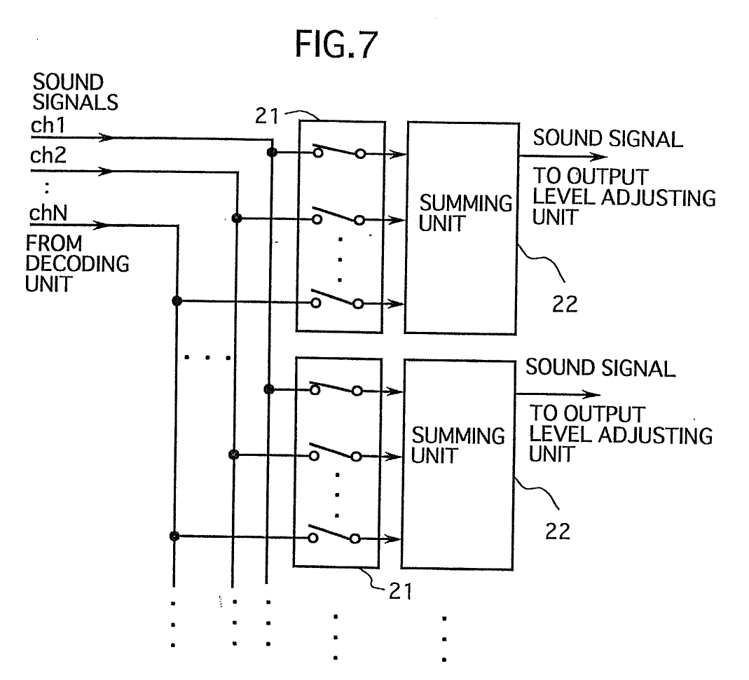

Referring now to the drawings to FIGS. 6 to 7, there is shown a second embodiment of the sound retrieval apparatus according to the present invention.

The second embodiment of the sound retrieval apparatus 20, as shown in FIG. 6, comprises a decoding unit 12, a matrix switch 13 including a selecting unit 21 and a summing unit 22, an output level adjusting unit 14, a detecting unit 15, a memory 16, a control unit 17, an operation unit 18, a level detecting unit 23, and a display unit 24.

The second embodiment of the sound retrieval apparatus 20 is the same as the first embodiment of the sound retrieval apparatus 10 except for the selecting unit 21 and the summing unit 22, the level detecting unit 23, and the display unit 24. The parts same as the first embodiment of the sound retrieval apparatus are not described in detail.

The selecting unit 21 constitutes selecting means for selecting the sound signals decoded by the decoding unit 12. The summing unit 22 constitutes summing means for summing the sound signals selected by the selecting unit 21. The level detecting unit 23 is utilized for detecting the output levels of the sound signals respectively on the channels. The display unit 24 constitutes display means for displaying the output levels of the sound signals respectively on the channels.

The switch matrix 13 in the second embodiment of the sound retrieval apparatus 20 is operative to select the sound signal on any channel for outputting to a plurality of speakers in accordance with the operation at the operation unit 18. For example, the sound signal on the first channel is selected and outputted to the center speaker 103 and the right speaker 102 at the same time. Further, the switch matrix 13 is operative to select and sum a plurality of sound signals for outputting to the speakers with the operation at the operation unit 18. For example, the sound signals on the first channel and the second channel are selected and outputted to the center speaker 103.

The switch matrix 13 includes the selecting unit 21 and the summing unit 22.

The selecting unit 21, as shown in FIG. 9, is operative to select the sound signals on the respective channels outputted from the decoding unit 12. The sound signals are selected in accordance with the operation at the operation unit 18. For example, in the case of two channels being selected, two channels of sound signals are outputted to the summing unit 22.

The summing unit 22 is operative to sum the sound signals selected by the selecting unit 21. The summed sound signals are outputted on the respective channels by the summing unit 22 in accordance with the operation at the operation unit 18.

The selecting unit 21 and the summing unit 22 are disposed on every channel between the decoding unit 12 and the output level adjusting unit 14. The sound signal on any channel may be selected by the selecting unit 21 and summed by the summing unit 22 in accordance with the operation at the operation unit 18, so that the sound signals on a plurality of channels may be outputted to the respective speakers. In short, any speaker may be selected for outputting the sound signals on a plurality of channels with the operation at the operation unit 18.

The level detecting unit 23 is operative to detect the output level of the sound signals outputted from the output level adjusting unit 14 on the respective channels. The output levels detected by the level detecting unit 23 are outputted to the display unit 24.

The display unit 24 is operative to display the output level of the sound signals on the respective channels detected by the output level detecting unit 23.

From the foregoing description it will be understood that the sound retrieval apparatus 20 according to the present invention thus constructed as previously mentioned that the sound signal on any channel is selected and summed with the sound signals on other channels for outputting to the respective speakers, so that the monitoring in various patterns is available.

Also, the sound retrieval apparatus 20 thus constructed as previously mentioned that the output levels of the sound signals on the respective channels are displayed so that the visual confirmation the output levels of the sound signals on the respective channels is available.

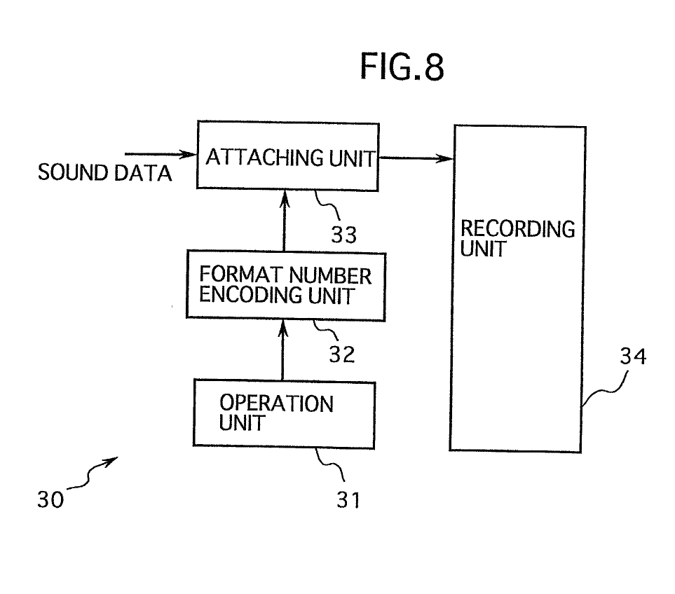

Referring now to the drawings in particular to FIG. 8, there is shown an embodiment of a sound data recording apparatus 30 according to the present invention.

The sound data recording apparatus 30 is the apparatus for recording the sound data and the attribute information to be obtained by the first embodiment of the sound retrieval apparatus 10 or the second embodiment of the sound retrieval apparatus 20.

The embodiment of the sound data recording apparatus 30, as shown in FIG. 8, comprises an operation unit 31, a format number encoding unit 32, an attaching unit 33, and a recording unit 34.

The operation unit 31 constitutes inputting means for having the identification data identifying a specific association between the channels for transmitting the sound signals thereon and the speakers inputted the sound signals thereto. The recording unit 34 constitutes recording means for recording the identification data attached to the sound data. The identification data is the format number which is the same as the format number in the first embodiment of the sound retrieval apparatus 10.

The operation unit 31 is operative to have the format number inputted thereto. The format number encoding unit 32 is operative to output the format number to the attaching unit 33.

The attaching unit 33 is operative to attach the format number to the sound data encoded from the sound signals on the respective channels.

The sound data attached the format number is outputted by the attaching unit 33 to the recording unit 34. The recording unit 34 is operative to record the sound data attached the format number in a recording medium.

In the case of the sound data encoded in the DVD specification standardized by the DVD forum, the format number is recorded in “Channel Assignment” area of the ATS (Audio Title Set) information. The “Channel Assignment” area is from bit 88 to bit 92 in the ATS information as shown in FIG. 9.

From the foregoing description, it will be understood that the sound data recording apparatus 30 according to the present invention thus constructed as previously mentioned can record the format number as the identification data identifying a specific association between the channels and the speakers with the sound data.

The sound retrieval apparatus according to the present invention can assign the channels for transmitting the sound signals thereon to the speakers inputted the sound signals thereto in accordance with the format number without any laborious task by the output patch board. Further, the sound retrieval apparatus according to the present invention can adjust the output levels of the sound signals on the respective channels in accordance with the format number without any laborious task. In addition, the sound data recording apparatus according to the present invention can record the identification data identifying a specific association between the channels and the speakers with the sound data.

What is claim is:

1. A sound retrieval apparatus for decoding sound data encoded in advance into a plurality of sound signals to be provided to a plurality of speakers for outputting sound in a three-dimensional sound field, said sound signals being respectively related to a plurality of channels; comprising:
decoding means for decoding said sound data into said sound signals respectively on said channels;
assigning means for assigning said channels to said speakers respectively based on the channel assignment information about a specific association between said channels and said speakers;
information storing means for storing said channel assignment information; and
control means for controlling said assigning means based on said channel assignment information to ensure that said sound signals on said channels are provided to said respective speakers in association with said channels.

2. A sound retrieval apparatus as set forth in claim 1, in which said control means is operative to judge whether there is sound data on said respective channels or not to cause said speakers in association with said channels having no sound data thereon to be inoperative.

3. A sound retrieval apparatus as set forth in claim 1, which further comprises output level adjusting means for adjusting the output levels of said sound signals respectively on said channels.

4. A sound retrieval apparatus as set forth in claim 3, in which said output level adjusting means is operative to adjust said output levels of said sound signals based on the output level information about a specific association between said channels and said output levels of said sound signals respectively on said channels, and said information storing means is operative to store said output level information.

5. A sound retrieval apparatus as set forth in claim 3, in which said output level adjusting means is operative to adjust respective said sound signals in equivalent ratio having said sound signals on said channels maintained in balance with one another.

6. A sound retrieval apparatus as set forth in claim 4, in which said output level adjusting means is operative to adjust respective said sound signals in equivalent ratio having said sound signals on said channels maintained in balance with one another.

7. A sound retrieval apparatus as set forth in claims 1 which further comprises selecting means for selecting said sound signals decoded by said decoding means, and summing means for summing said sound signals selected by said selecting means to output summed sound signals to respective said speakers.

8. A sound retrieval apparatus as set forth in claims 3 which further comprises selecting means for selecting said sound signals decoded by said decoding means, and summing means for summing said sound signals selected by said selecting means to output summed sound signals to respective said speakers.

9. A sound retrieval apparatus as set forth in claims 1 which further comprises display means for displaying the output levels of said sound signals respectively on said channels.

10. A sound retrieval apparatus for decoding sound data encoded in advance into a plurality of sound signals to be provided to a plurality of speakers for outputting sound in a three-dimensional sound field, said sound signals being respectively related to a plurality of channels; comprising:
decoding means for decoding said sound data into said sound signals respectively on said channels;
assigning means for assigning said channels to said speakers respectively in accordance with the identification data identifying a specific association between said channels and speakers;
detecting means for detecting said identification data attached to said sound data;
control means for controlling said assigning means in accordance with said identification data to ensure that said sound signals on said channels are provided to said respective speakers in association with said channels.

11. A sound retrieval apparatus as set forth in claim 10, in which said control means is operative to judge whether there is sound data on said respective channels or not to cause said speakers in association with said channels having no sound data thereon to be inoperative.

12. A sound retrieval apparatus as set forth in claim 10, which further comprises output level adjusting means for adjusting the output levels of said sound signals respectively on said channels.

13. A sound retrieval apparatus as set forth in claim 12, in which said output level adjusting means is operative to adjust said output levels of said sound signals based on the output level information about a specific association between said channels and said output levels of said sound signals respectively on said channels, and said information storing means is operative to store said output level information.

14. A sound retrieval apparatus as set forth in claim 12, in which said output level adjusting means is operative to adjust respective said sound signals in equivalent ratio having said sound signals on said channels maintained in balance with one another.

15. A sound retrieval apparatus as set forth in claim 13, in which said output level adjusting means is operative to adjust respective said sound signals in equivalent ratio having said sound signals on said channels maintained in balance with one another.

16. A sound retrieval apparatus as set forth in claims 10 which further comprises selecting means for selecting said sound signals decoded by said decoding means, and summing means for summing said sound signals selected by said selecting means to output summed sound signals to respective said speakers.

17. A sound retrieval apparatus as set forth in claims 12 which further comprises selecting means for selecting said sound signals decoded by said decoding means, and summing means for summing said sound signals selected by said selecting means to output summed sound signals to respective said speakers.

18. A sound retrieval apparatus as set forth in claims 10 which further comprises display means for displaying the output levels of said sound signals respectively on said channels.

19. A sound data recording apparatus for recording sound data encoded in advance from a plurality of sound signals to be provided to a plurality of speakers outputting sound in a three-dimensional sound field, said sound signals being respectively related to a plurality of channels; comprising:
inputting means for having the identification data identifying a specific association between said channels and speakers inputted thereto; and
recording means for recording said identification data attached to said sound data.
